(19) United States
(12) Patent Application Publication
(10) Pub. No.: US 2001/0003333 A1
(43) Pub. Date: Jun. 14, 2001

(54) Method for processing mineral-insulated conduits

(75) Inventor: Lucas Neven, Tongeren (BE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/731,568

(22) Filed: Dec. 7, 2000

(30) Foreign Application Priority Data
Dec. 7, 1999 (DE) DE 199 58 763.9

(51) Int. Cl. B23K 26/38

(52) U.S. Cl. 219/121.72

(57) ABSTRACT

A method is provided for processing mineral-insulated conduits, in particular for stripping the insulation from and/or severing mineral-insulated conduits, wherein a mineral-insulated conduit is constructed of at least one wire or band-shaped electrical conductor, a mineral powder and a metallic sheath tube having a wall thickness a. The problem arises, in reference to the known disadvantages of the prior art, to make available an improved method for processing mineral-insulated conduits. This problem is solved by a method where the sheath tube is processed on at least one radial processing line using laser cutting, and starting from the radial processing line, the sheath tube is processed on at least one axial processing line using laser cutting. The mineral-insulated conduit is then treated with ultrasound.

### BACKGROUND OF THE INVENTION

The invention relates to a method for processing mineral-insulated conduits, in particular for stripping off the insulation and/or severing of mineral-insulated conduits, wherein a mineral-insulated conduit is constructed from at least one wire or band-shaped electrical conductor, a mineral powder and a metallic sheath tube having a wall thickness a.

Such a method, which is performed with the aid of a rotating separating disc, is known. In that method, a separating disc radially cuts through, if possible, only the metallic sheath tube of a pre-manufactured, mineral-insulated conduit.

PCT application publication WO 97/37391 describes a method for manufacturing mineral-insulated thermoelements. There, a metallic tube is cut to a prespecified length, and one end of the tube is closed, for example by welding. The thermoelement-wires made from different metals are bonded with the formation of a molten bead and arranged near the closed end of the metallic tube. The wire ends are conducted out of the tube in parallel, and the intermediate space between thermoelement wires and the tube are filled using a mineral powder to form an electrical insulation. Then, the diameter of the thus-filled metallic tube is reduced.

UK published patent application GB 2 288 695 A describes a device, preferably for stripping the insulation from mineral-insulated conduits. One end of an already pre-manufactured mineral-insulated conduit is there enclosed by adjustable clamping jaws. Then, a blade is moved together with the clamping jaws around the axis of the mineral-insulated conduit, and the metal sheath is thereby severed.

The methods mentioned for processing pre-manufactured mineral-insulated conduits use either rotating or fixed cuts, whose immersion depth into the metallic sheath tube is mechanically adjusted or changed. The condition of the blade therein is also subject to the considerable appearances of ageing, so that the change of the immersion depth must also take place based on wear. There is the danger that with these methods, one of the electrical conductors in the interior of the metallic sheath tube is damaged or severed.

There results the problem, with reference to the known disadvantages of the prior art, of making available an improved method for processing mineral-insulated conduits

### BRIEF SUMMARY OF THE INVENTION

This problem is solved in that the sheath tube is processed using laser cutting on at least one radial processing line and, starting from the radial processing line, the sheath tube is processed on at least one axial processing line using laser cutting. Then, the mineral-insulated conduit is treated with ultrasound.

This method is on the whole very cost-effective and suitable for processing mass-production quantities. A reason for this is to be found in the laser itself which, in comparison to a separating disc or blade, has a service life that is many times longer. Based on the fact that the laser in addition operates without mechanical wear, the immersion depth of the laser light into the metallic sheath tube is always the same after a one-time adjustment which, moreover, can be done in a very precise manner. Consequently, an intentional partial severing or a perforation of the sheath tube is also possible. The method is accordingly suitable for introducing a defined breaking line in the sheath tube, which can then be broken open using ultrasound. High processing speeds are achievable. There is no danger of damage to the electrical conductor in the sheath tube with the method according to the invention.

The processing speed can be further increased, if several lasers arranged radially around the mineral-insulated conduit to be processed are simultaneously used to make one radial or two axial processing lines. Thus, for example, two lasers at an angle of 180° to each other can be arranged radially to a mineral-insulated conduit. These two lasers should each be able to describe an angle of 185°around the mineral-insulated conduit, and during this provide the metal sheath tube with a radial processing line. Of course, for this purpose, the mineral-insulated conduit itself can be moved instead. There results a radial processing line without offset. The use of two lasers leads almost to a halving of the processing time with laser cutting. When using more than two lasers, the processing times can indeed be further shortened, but of course the costs for the laser cutting device increase with each additional laser.

It is especially advantageous if the wall thickness a of the sheath tube is reduced at least at points up to at least 50%, particularly up to 90%, using laser cutting.

It has proven to be useful, especially for the beginning or the end of a premanufactured mineral-insulated conduit, if the sheath tube is provided using laser cutting with a radial processing line near one end of the sheath tube, if the sheath tube is provided using laser cutting with two axial processing lines between the radial processing line and the end of the sheath tube, and if the mineral-insulated conduit is then treated using ultrasound.

In order to sever a mineral-insulated conduit it has proven to be useful if the sheath tube is provided using laser cutting with two radial processing lines spaced from each other, if the sheath tube is provided with two axial processing lines between the two radial processing lines, starting from one of the radial processing lines, and if the mineral-insulated conduit is then treated using ultrasound. Of course, the application of more than two axial processing lines is also possible, but of course processing times are thereby prolonged.

Using the ultrasound treatment of the mineral-insulated conduit, on the one hand, parts of the sheath tube, which are bordered by the processing lines, are removed, and on the other hand, the mineral powder in the region of these parts of the sheath tube is removed. The parts of the sheath tube, which are bordered by the processing lines, are preferably formed as half-shells.

After the treatment of the mineral-insulated conduit using ultrasound, the open-lying electrical conductor can be severed. This can take place by all known severing methods, as for example, mechanically by cutting or thermally by melting it open. However, in regard to a production manufacturing line, severing by laser cutting is advantageous.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side view of a mineral-insulated conduit processed according to the invention with two radial and four axial processing lines;

FIG. 2 is a view of the mineral-insulated conduit according to FIG. 1 after the ultrasound treatment of the invention;

FIG. 3 is the mineral-insulated conduit according to FIG. 1 and FIG. 2 in cross-sectional view;

FIG. 4 is a side view of a mineral-insulated conduit processed according to the invention with two radial and two axial processing lines;

FIG. 5 is a view of the mineral-insulated conduit according to FIG. 4 after the ultrasound treatment of the invention; and

FIG. 6 is the mineral-insulated conduit according to FIG. 5 after severing of the electrical conductors.

### DETAILED DESCRIPTION OF THE INVENTION

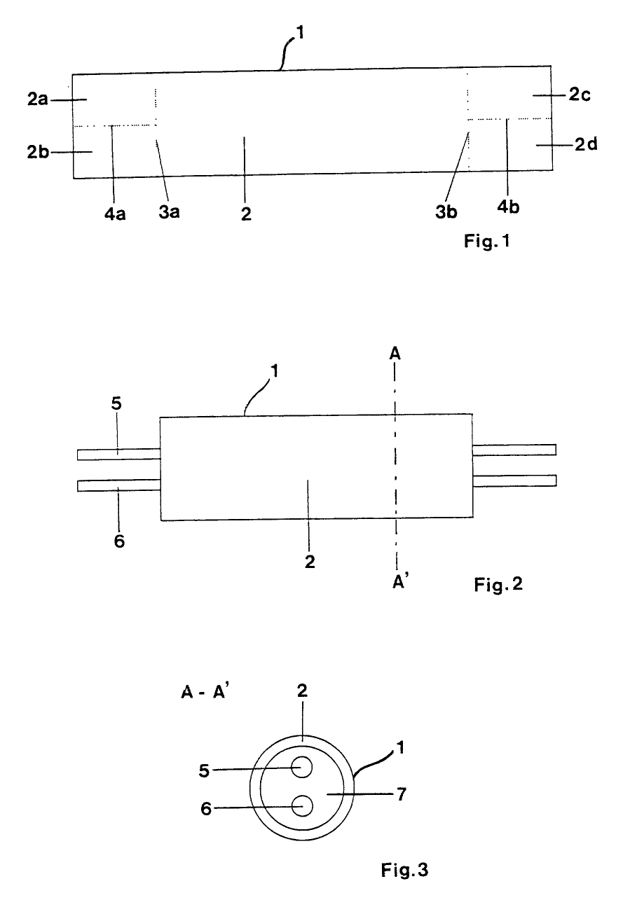

FIG. 1 shows a mineral-insulated conduit 1 with a metallic sheath tube 2. The sheath tube 2 is provided at both ends of the mineral-insulated conduit 1 with a respective surrounding radial processing line 3a, 3b on its periphery using laser cutting. Two respective axial processing lines are arranged at the same time using laser cutting at an angle of 180°on the sheath tube 2 between one end of the mineral-insulated conduit and a radial processing line 3a, 3b. Of the total four axial processing lines, only two axial processing lines 4a, 4b are seen in this drawing. The two other axial processing lines are not visible, being located on the rear side of the mineral-insulated conduit 1. On the two ends of the mineral-insulated-conduit 1, four half-shell shaped parts 2a, 2b, 2c, 2d of the sheath tube 2 are circumscribed by the two axial processing lines 4a, 4b as well as by the two non-visible axial processing lines on the rear side of the mineral-insulated conduit 1 and by the radial processing lines 3a, 3b.

FIG. 2 shows the mineral-insulated conduit 1 according to FIG. 1 after a treatment with ultrasound. The axial and radial processing lines were broken open using ultrasound, and the half-shell shaped parts of the sheath tube 2 were removed. The mineral powder, located inside the half-shell shaped parts, was simultaneously removed using ultrasound. The electrical conductors 5, 6 now project at both ends beyond the mineral-insulated conduit 1 and can be contacted. The two ends of the mineral-insulated conduit 1 can be closed in a known way. For this purpose, depending on the temperature use range, one end can be closed, for example by a glass solder or an epoxy resin.

FIG. 3 shows a cross section A-A′ through the mineral-insulated conduit 1 with the metallic sheath tube 2, the two electrical conductors 5, 6 and the mineral powder 7. As a mineral powder, for example, MgO-powder can be used.

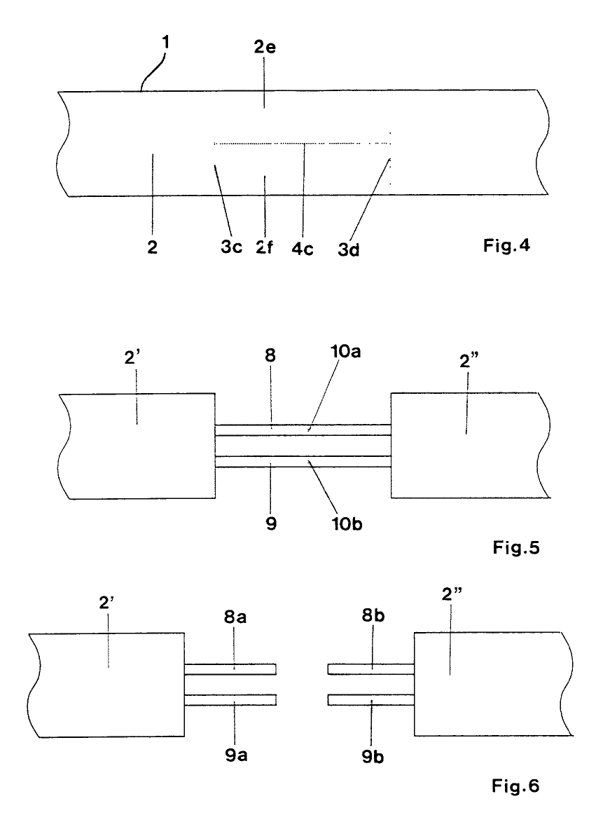

FIG. 4 shows a mineral-insulated conduit 1 with a metallic sheath tube 2. The sheath tube 2 is provided in the middle on its periphery with two surrounding radial processing lines 3c, 3d using laser cutting. Two axial processing lines are arranged at the same time using laser cutting at an angle of 180°on the sheath tube 2 between the radial processing lines 3c, 3d. Of the two axial processing lines, only one axial processing line 4c can be seen in this drawing. The other axial processing line is located non-visibly on the rear side of the mineral-insulated conduit 1. The axial processing line 4c as well as the non-visible axial processing line on the rear side of the mineral-insulated conduit 1 and the radial processing lines 3c, 3d enclose two half-shell shaped parts 2e, 2f of the sheath tube 2.

FIG. 5 shows the mineral-insulated conduit 1 according to FIG. 4 after a treatment with ultrasound. The axial and radial processing lines were broken open using ultrasound, and the half-shell shaped parts of the sheath tube 2 were removed. The mineral powder located within the half-shell shaped parts was simultaneously removed using ultrasound. The sheath tube is now subdivided into two parts 2′, 2″, and the electrical conductors 8, 9 are visible. Two laser cuts 10a, 10b sever the electrical conductors 8, 9 in the middle.

FIG. 6 shows the electrical conductors 8a, 8b, 9a, 9b, which are already severed using laser cutting and can now be contacted. The ends can be closed in a known way prior to or after separation of the electrical conductors. For this purpose, depending on the temperature use range, one end can be closed, for example by a glass solder or an epoxy resin.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for processing mineral-insulated conduits, in particular for stripping off insulation and/or severing of mineral-insulated conduits, wherein a mineral-insulated conduit comprises at least one wire or band-shaped electrical conductor, a mineral powder and a metallic sheath tube having a wall thickness a, the method comprising laser cutting the sheath tube on at least one radial processing line, laser cutting the sheath tube on at least one axial processing line starting from the radial processing line, and then treating the mineral-insulated conduit with ultrasound.

2. The method according to claim 1, wherein a wall thickness a of the sheath tube is reduced at least at points up to at least 50% using laser cutting.

3. The method according to claim 2, wherein the wall thickness a of the sheath tube is reduced at least at points up to at least 90% using laser cutting.

4. The method according to claim 1, wherein the sheath tube is provided near one end of the sheath tube with a radial processing line using laser cutting, the sheath tube is provided with two axial processing lines between the radial processing line and the end of the sheath tube using laser cutting, and the mineral-insulated conduit is then treated using ultrasound.

5. The method according to claim 1, wherein the sheath tube is provided with two radial processing lines spaced from each other using laser cutting, the sheath tube is provided with two axial processing lines between the two radial processing lines starting from one of the radial processing lines, and the mineral-insulated conduit is then treated using ultrasound.

6. The method according to claim 1, wherein using the ultrasound treatment of the mineral-insulated conduit, parts of the sheath tube bordered by the processing lines are removed, and the mineral powder in a region of these parts of the sheath tube is removed.

7. The method according to claim 6, wherein the parts of the sheath tube bordered by the processing lines have a form of half-shells.

8. The method according to claim 1, wherein after the ultrasound treatment of the mineral-insulated conduit, at least one electrical conductor is severed.

9. The method according to claim 8, wherein the severing is performed using laser cutting.
